(19) United States
(12) Patent Application Publication
(10) Pub. No.: US 2025/0310007 A1
(43) Pub. Date: Oct. 2, 2025

(54) Transceiver Delay Calibration Systems and Methods

(71) Applicant: Altera Corporation, San Jose, CA (US)

(72) Inventors: Conor O'Keeffe, Cork (IE); Finbarr O'Regan, Innishannon (IE)

(21) Appl. No.: 19/233,726

(22) Filed: Jun. 10, 2025

(51) Int. Cl. H04B 17/14; H04B 17/21; H04L 27/36

(52) U.S. Cl. CPC H04B 17/14; H04B 17/221; H04L 27/36

(57) ABSTRACT

Systems, methods, and circuitry for determining a delay through a modem of a transceiver are provided. An integrated circuit system may include a transmit signal path, delay calibration circuitry, and a phase detector. The delay calibration circuitry may allow determination of a delay through a transmit signal path between a calibration sequence signal source and an output of the transmit signal path. The transmit signal path may include a number of processing stages having a possible delay variation under different conditions. The phase detector may determine a fractional baud rate difference between the calibration sequence signal source and a signal representative of the output of the transmit signal path

### BACKGROUND

This disclosure relates to systems and methods to calibrate communication systems for delay through a transmit signal path or a receive signal path, enabling higher-precision time synchronization and ranging.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include programmable logic circuitry that may be configured with a hardware system design to implement hardware designs that may perform a wide variety of different functions. Some integrated circuits, sometimes including programmable logic circuitry, are used to rapidly process communication with other integrated circuits. For example, satellite networks may use integrated circuits to process data signals that are transmitted optically over long distances. High-frequency trading systems may correspondingly transmit data signals optically to reduce latency. Communication systems like these use precise time synchronization between electronic devices to operate.

For example, the synchronization of time across satellites is used to determine location in relation to the satellite from ground and between satellites. To do this, signals on optical inter-satellite links (OISLs) are timestamped so as the coordinated universal time clocks (UTCs) of the satellites can be propagated across the satellite constellation. The accuracy of the time-base on each of the satellites affects the accuracy of any location-based tracking. Correspondingly, the accuracy of relayed timestamps across the satellite network depends on the time of flight of the signal and propagation delay through the transmit and receive optical, interconnect and electronic circuits. The delay can vary as a function of operating conditions, such as operating wavelength, temperature of devices, clock phase, insertion delay and, in some cases, even the mechanical position of the optical systems. This variable propagation delay through the transmit and receive optical, interconnect and electronic circuits could result in variable ranging accuracy. Time synchronization also greatly affects the effectiveness of communication systems for high-speed trading. Thus, variable propagation delays through these communication systems may negatively impact their effectiveness. What is more, resolving for time delay using clock signals of an electronic device may involve at least a 1 GHz clock for accuracy to +/− 1 nS. For the picosecond domain, up to three orders of magnitude higher clock frequency logic would be involved, and logic running at THz clock speeds appears to be at least two orders of magnitude beyond current state of the art.

### BRIEF DESCRIPTION OF THE DRAWINGS

Various aspects of this disclosure may be better understood upon reading the following detailed description and upon reference to the drawings in which:

FIG. 1 is a block diagram of a system used to program a system design onto an integrated circuit device;

FIG. 2 is a block diagram of an example integrated circuit device that may be programmed with a system design;

FIG. 3 is a schematic diagram of a satellite network that uses integrated circuit devices to precisely calculate distance from one satellite to another by precisely calibrating for signal path delays;

FIG. 4 is a block diagram of components that may be found in satellites of the satellite network;

FIG. 5 is a block diagram of a data processing system to enable highly precise time synchronization, enabling features such as highly precise high-frequency trading;

FIG. 6 is a block diagram of a communication system that may be used for a variety of use cases, such as the satellite network or the data processing system;

FIG. 7 is a flowchart of a method for calibrating the communication system;

FIG. 8 is a flowchart of a method for determining a precise delay over a transmit signal path of the communication system;

FIG. 9 is a flowchart of a method for determining a precise delay over a receive signal path of the communication system;

FIG. 10 is a block diagram of an electronic device including circuitry to calibrate for delay over a transmit signal path and a receive signal path;

FIG. 11 is a timing diagram illustrating an example calibration sequence signal;

FIG. 12 is a timing diagram illustrating a method for determining a fractional difference between a calibration signal path and the transmit signal path;

FIG. 13 is a plot illustrating a voltage corresponding to the fractional difference between the calibration signal path and the transmit signal path;

FIG. 14 is a diagram illustrating a method for distinguishing between lagging and leading phase differences between the calibration signal path and the transmit signal path;

FIG. 15 is a flowchart of another method for calibrating the communication system; and

FIG. 16 is a block diagram of a data processing system that may incorporate the systems and methods of this disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another.

Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

This disclosure relates to precise synchronization of time across electronic devices. Many communication systems, such as satellite networks or trading systems for high-frequency trading, greatly benefit from highly precise time synchronization. Indeed, the synchronization of time across satellites is a major part of a location service. To do this, signals on optical inter-satellite link (OISL) links are timestamped so that the coordinated universal time clock (UTC) can be propagated across the satellite constellation. In addition, the Space Development Agency (SDA) of the United States Space Force specifies that the onboard communication terminal shall collect the transmit timestamp from the header of received modem frames and provide these to the host for two-way time transfer (TWTT) and position, navigation, and timing (PNT) processing. To keep the precision and accuracy of any location-based tracking to a meter or mm on the ground, the precision and accuracy of the time-base on each of the satellites may be in the order of a few nanoseconds or even picoseconds, respectively. The accuracy of relayed timestamps depends on the time of flight of the signal and propagation delay through the transmit and receive optical, interconnect and electronic circuits. The delay can vary as a function of operating wavelength, temperature of devices and, in some cases, even the mechanical position of the optical systems. Measurement in orbit of the delay through optical signal processing paths is therefore desirable to calibrate timestamp off-sets correctly.

The Space Development Agency (SDA) of the United States Space Force, among other organizations, has defined a timing stamp on the header of OISL protocol frames to propagate a UTC between satellites. This allows the satellite time to be updated and synchronized across a constellation of satellites. This feature can also be used as security to reduce or eliminate spoofing where timestamps do not fall within a defined window. This time stamping can also be used by satellites to aid position, navigation, and timing (PNT), ensuring that the orbital position is maintained. Systems and methods of this disclosure may be used to precisely measure propagation delays through transmit signal paths and receive signal paths of electronic devices in a communication system. Calibrating for these delays accurately is one of the breakthroughs that enables this technology. Indeed, the systems and methods of this disclosure may enable low-earth orbit (LEO) constellations to synchronize clocks and enable an alternative or complement to GPS for navigation.

More generally, this scheme can apply to any transceiver, optical, electrical or radio frequency (RF) for which a precise processing path delay may be beneficial. Applications for such technology include financial technology (fintech) where timing of trades is particularly critical. Indeed, serializer/deserializer (SERDES) modems can also be timestamped using the proposed method (e.g., whereas the examples of this disclosure relate to optical communication, to operate with RF or electrical systems, the optical feedback loop may be replaced by an electrical feedback loop).

Indeed, while this disclosure focuses on OISL links, the systems and methods of this disclosure can be used in other domains, such as optical interconnect links on terrestrial networks and data centers. The technique and apparatus are not even confined to optical interconnects but also to electrical interconnects such as those used in backplane interconnect using protocols such as PCIe and Ethernet. This technique may also apply to antenna arrays where the interconnect of data propagating to different antenna elements is applied digitally using protocols such as JESD204B/C.

Technology domains where more accurate Precision Time Protocol (PTP) would be advantageous include the financial technology space, where high-bandwidth trading relies on small margins of execution delays. Other domains include large scientific clock synchronization for more efficient telecom networks and scientific experiments. For PTP, a reliance on IEEE 1588 protocols may be used. Here, ranging forms a valuable part of the time transfer method and is a limiting factor on precision. The delay calibration systems and methods of this disclosure may greatly improve the accuracy and precision of these types of communication systems. Note that, while the embodiments described herein primarily focus on the delay through an optical modem, these techniques could be employed on a radio frequency (RF) transmit and receive system or even serialized electrical digital data transmission systems. Moreover, precision delay measurements of propagation of a signal could also be employed to measure the propagation of a signal in other systems where precision time of delay is used, such as in the proliferation of accurate time within a computing system. This could be, for example, a signal whose transition in state signifies, for example, a second boundary transition from an originating clock to be compared to a local clock.

These communication systems may include a programmable logic device such as a field programmable gate array (FPGA) or an application-specific integrated circuit (ASIC). The programmable logic device or ASIC may include a system design that may be used to calculate a time delay through a transmit path, a transmit path and a receive path, and therefore through the receive path. An accurate measurement of the time delay allows the programmable logic device or ASIC to adjust a timestamp for outgoing communication and calculate a time-of-flight for incoming communication.

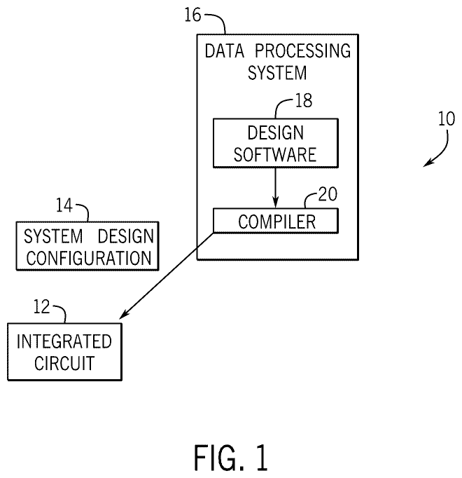

FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with such a system design in a system design configuration 14. Note that, while this disclosure largely refers to the integrated circuit device 12 as being a programmable logic device, such as an FPGA, in some embodiments, the integrated circuit device 12 may also be a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of Altera® Quartus® by Altera Corporation. The data processing system 16 may use the design software 18 and a compiler 20 to convert the high-level program into a lower-level description (e.g., a configuration program, a bitstream) as the system design configuration 14. The designer may use the design software 18 to generate and/or to specify a low-level program, using low-level tools such as the low-level hardware description languages described above.

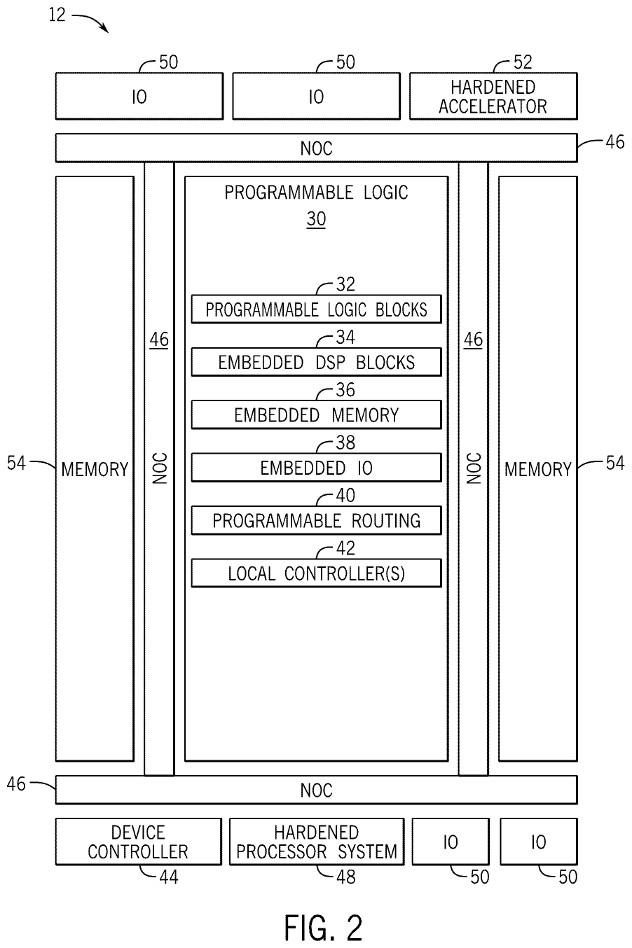

The integrated circuit device 12 may take any suitable form that may implement the system design configuration 14. In one example shown in FIG. 2, the integrated circuit device 12 may include programmable logic circuitry 30, which include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may be programmed into the programmable logic blocks 32 to perform the same functions, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic circuitry 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic circuitry 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic circuitry 30 of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic circuitry 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic circuitry 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic circuitry 30.

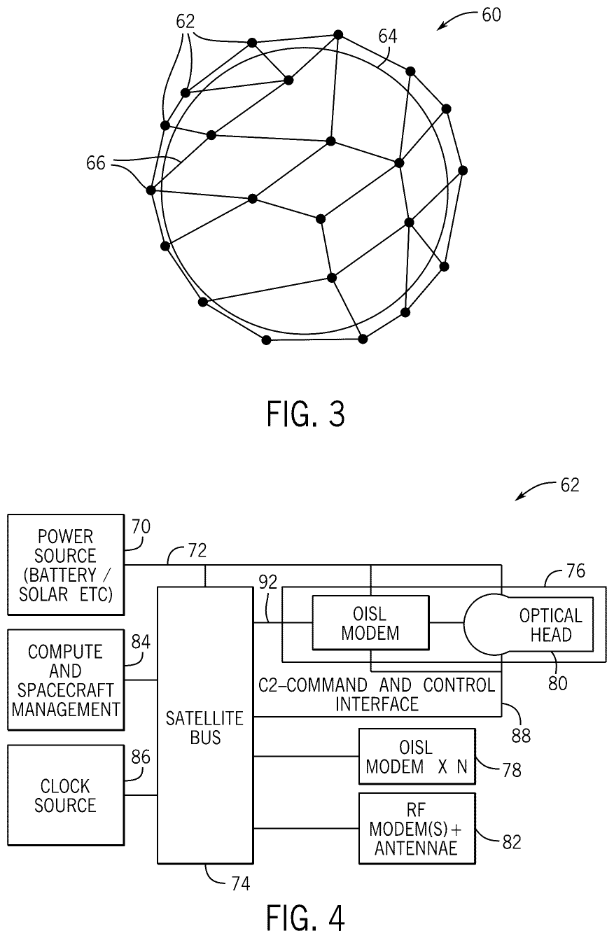

The integrated circuit device 12 may be a component in a number of different possible communication systems. One such communication system is a satellite network 60 shown in FIG. 3. The satellite network 60 includes a number of satellites 62 in orbit over a planet 64 (e.g., Earth). The satellites 62 can be in low earth orbit (LEO), medium-earth orbit (MEO), geosynchronous equatorial orbit (GEO), or the like. Each satellite 62 can form optical inter-satellite link (OISL) links 66 between other satellites 62 or terrestrial objects such as ground stations or aircraft.

The satellites 62 may send data and timing information to each other via the OISL links 66. A mesh network is formed when two or more satellites 62 can relay information to one another. Due to the motional orbit of the satellites 62 and depending on their respective orbits, the satellites 62 may occasionally change which other satellites 62 to which they are OISL-connected. For LEO, the connection range with other satellites 62 can be limited to approximately 5000 km links, owing to the planet horizon obscuring the view. Other links, for example MEO to GEO, can be up to 80,000 km.

Pointing laser beams between the satellites 62 involves accurate tracking and pointing to the connected target satellite 62. In LEO orbits, for example, each satellite 62 may have a velocity of 25,000 km/hr and may orbit the planet in approximately 90 minutes. The satellite network 60 may include a constellation of thousands of satellites 62.

FIG. 4 is a block diagram of components that may be used by a satellite 62 to communicate with other satellites 62 or with a ground station or aircraft. A power source 70 may supply energy via power supply lines 72 to the various components of the satellite 62. Note that, while the power supply lines 72 are shown connected to a satellite bus 74 and an optical communication component 76 formed from an OISL modem 78 coupled to an optical head 80, the power source 70 may supply power (via other power supply lines not shown) to the other components of the satellite 62 or these components may rely on a separate power source. Because LEO satellites, in particular, spend much of their time eclipsed by the planet, the power source 70 may include a solar power source (e.g., photovoltaic) and a battery backup to provide energy when solar is not available. Note that radio frequency (RF) modems and antennae 82 may also be present. These are most used for planetary links such as, for example, ground station links or user links.

The satellite bus 74 (sometimes referred to as a spacecraft bus) is the main body and structural component of the satellite 62, in which the payload and scientific instruments are held. It may also contain conduits for power, data, and clocks to be distributed to other modules of the satellite 62. Other components plugged into the satellite bus 74 include compute and spacecraft management circuitry 84, which may be used to manage the guidance and stability functions of the satellite 62. The compute and spacecraft management circuitry 84 can also be used for control of the power, thermal management, and processing telemetry data of the modems. The satellite bus 74 may have a data-plane packet switch within or adjacent to the compute and spacecraft management circuitry 84 for managing routing the data to the various modems 78, 82 operating on the satellite 62.

In most satellite buses 74, clock sources 86 provide accurate local clock signals for several reasons. Satellites 62, given their velocity, use ranging to track their space position accurately as other satellites 62 acquiring the OISL do as well. A single satellite 62, traveling at 25,000 km/hr travels over 8 km/second, meaning that two satellites 62 traveling at this velocity in opposite directions could be 16.5 km/s. If clocks are wrong on any one of the satellites 62, then the pointing acquisition and tracking (PAT) of the OISL optical head 80 system may not work, owing to trying to track another satellite 62 at the wrong spatial location. Furthermore, as already mentioned, clocks are used to relay time accurate information for planetary terrestrial services such as geo-location.

More than one OISL modem 78 can be used by a single optical head 80 to support redundancy in the satellite 62 platform or as a way to scale OISL bandwidth. In addition, more than one OISL optical head 80 may be on each satellite 62 (not shown for ease of explanation). Routinely, four or more optical heads 80 (not shown) may be installed on a satellite 62. This allows for mesh networks formed across a constellation of satellites 62. Each optical head 80 may include an optical telescope and various modules such as a gimbal (e.g., to enable telescope pointing), pointing acquisition and tracking (PAT) hardware, an optical low noise amplifier (LNA) for receiving communication channels, and an optical high-power amplifier (OHPA) for amplifying transmit signals. An optical filter of the optical head 80 may isolate transmit signals from receive signals and isolate background solar radiation. A beacon laser and beacon sensors of the optical head 80 may support PAT. A compute node of the optical head 80 may support a command and control (C2) interface 88 and may process ephemeris information to deduce gimbal pointing angles and doppler estimation. The compute and spacecraft management circuitry 84 may control the operation of the optical head(s) 80 via the C2 interface 88.

The optical head 80 may receive or transmit optical signals 90 via an OISL optical connection to other satellites 62, ground stations, or aircraft. The OISL modem 78 processes the optical signals 90 into electrical data signals 92 that can be used by other components of the satellite 62. The OISL modem 78 includes optical-to-electrical circuits for the receive functions; conversely, it includes electrical-to-optical circuits for transmit functions. The OISL modem 78 includes the analog-to-digital signal processing of the receive signals. The digital signal processing on the receive path performs filtering, channel equalization, doppler correction, demodulation, clock and data recovery (CDR), de-framing, and forward error correction (FEC) decoding, followed by relaying data to the compute and spacecraft management circuitry 84 via the satellite bus 74. Conversely, on the transmit processing path, the functions of the OISL modem 78 include processing data payloads from receiving ethernet ports, FEC encoding, protocol framing, modulation formatting, filtering, optical/analog impairment corrections, digital-to-analog conversion, filtering, gain stages, optical modulators (e.g., a Mach-Zehnder modulator (MZM)), and fiber coupling.

The time that data traverses the transmit path and receive path between the optical head 80 and the compute and spacecraft management circuitry 84 (e.g., through the OISL modem 78) may vary under different conditions (e.g., operating wavelength, temperature, mechanical position). Yet, as mentioned above, precise ranging between two satellites 62 depends on a precise understanding of the time of flight of the optical signal between the satellites 62 (e.g., from one optical head 80 of one satellite 62 to another optical head 80 of another satellite 62). As such, the OISL modem 78 or the compute and spacecraft management circuitry 84 may determine a precise measurement of the delay introduced by the OISL modem 78, which will be discussed further below. The delay introduced by the optical head 80 may be determined using any suitable method, including those described in Patent Cooperation Treaty Application No. PCT/US2024/035941, “OPTICAL INTERCONNECTS FOR FLEXIBLE CALIBRATION OF AN OPTICAL TRANSCEIVER IN A FREE-SPACE OPTICAL COMMUNICATION SYSTEM,” which is incorporated by reference herein in its entirety for all purposes. Based on these calculations of delay, the timestamps for messages transmitted or received by the satellite 62 may be adjusted so that the timestamps correspond to the moment that the optical signal exits or enters the optical head 80. This allows for a determination of the time of flight between two satellites 62 under changing conditions.

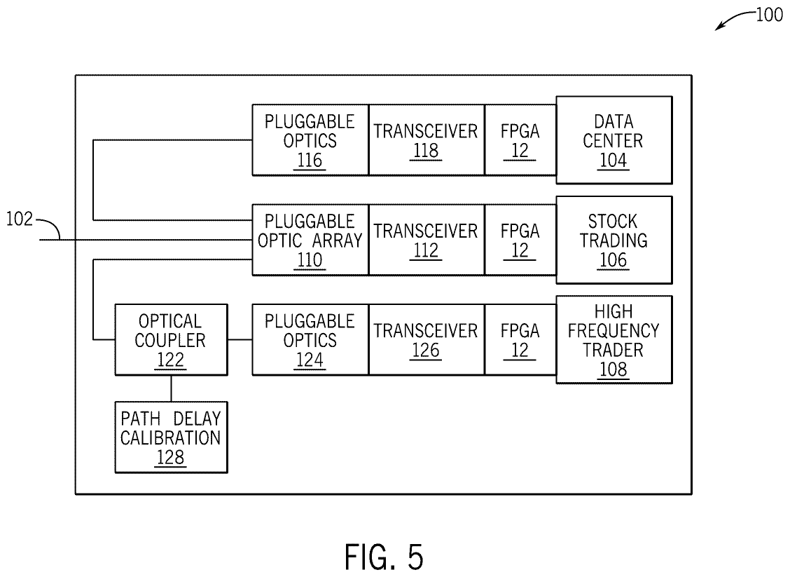

Similar calculations of delay may be useful in other use cases. For example, as shown in FIG. 5, a financial trading system 100 may also benefit from precise time synchronization. The financial trading system 100 may use optical communication 102 to ensure extremely rapid communication with other financial systems. Additionally or alternatively, the financial trading system 100 may use other forms of communication (e.g., radio frequency (RF) or wireline).

Time is critical for trading systems for several reasons, including order execution, market data analysis, and trade settlement. The primary reasons for this are to avoid discrepancies, sequencing issues, disputes, and failed settlements. Specialized high-frequency trading firms reduce network latency by being co-located with the exchange. In addition, some European regulations may specify that trades be time stamped to the nearest 100 μs, while the U.S. Securities and Exchange Commission specifies a consolidated audit trail (CAT), which is stored in a national market system database. Systems capable of more accurate timing must report that timing to the CAT. The systems and methods of this disclosure may allow for timestamping to highly precise (e.g., nanosecond to picosecond levels), providing a significant benefit to the financial trading system 100.

In the example of FIG. 5, the financial trading system 100 includes a data center 104, a stock trading platform 106, and a high-frequency trading platform 108, but more or fewer platforms may be included in other examples. A pluggable optic array 110 may distribute the optical communication 102 for the various platforms of the financial trading system 100. In other examples, each platform may transmit and receive optical signals independently.

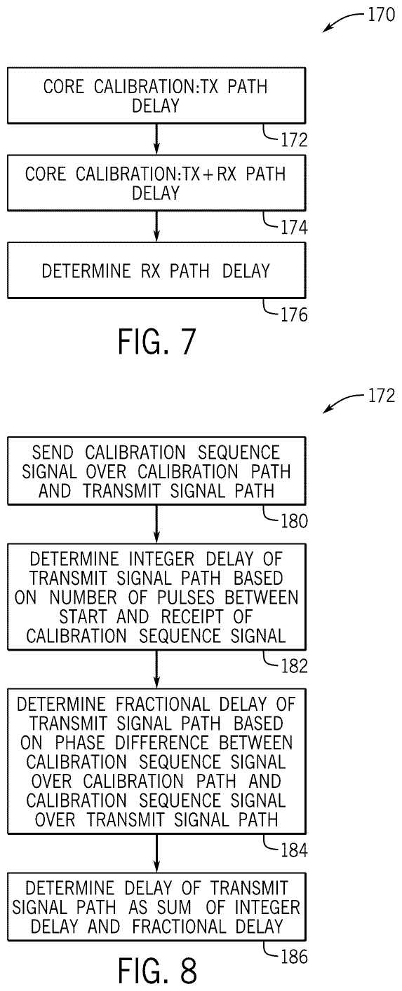

A transceiver 112 may receive or transmit the signals from the pluggable optic array 110 that are sent to or received from the stock trading platform 106. An integrated circuit device 12 (e.g., an FPGA) may rapidly process messages to or from the transceiver 112 for the stock trading platform 106. Pluggable optics 116 associated with the data center 104 may optically couple to the pluggable optical array 110. A transceiver 118 may receive or transmit signals that are sent to or received from the data center 104. An integrated circuit device 12 (e.g., an FPGA) may rapidly process messages to or from the transceiver 118 for the data center 104. While time synchronization is valuable for the data center 104 and the stock trading platform 106, it is especially useful for the high-frequency trading platform 108. As such, as optical communication 102 is received into an optical coupler 122 and/or pluggable optics 124, and processed through a transceiver 126 and/or an integrated circuit device 12 (e.g., an FPGA) associated with the high-frequency trading platform 108, the integrated circuit device 12 may perform a path delay calibration 128 to enable exceptionally precise time synchronization. The path delay calibration 128 may take place in the manner described with reference to FIGS. 7-15 below.

Indeed, the systems and methods of this disclosure involve determining the transmit and receive path delays through a modem, regardless of latency, digital clock domains, first-in-first-out buffer (FIFO) usage and other uncertainties. The delay can be calibrated during manufacture or during mission mode.

One of biggest issue with many modems is that the path delay changes with each power up sequence. Much of this delay variation between power-up cycles is due to clock domain crossing circuits and the varying pointer phases of clocks used in FIFO registers. Also, optical wavelengths can cause different calibration responses on correction blocks such as digital pre-distortion (DPD) and in-phase (I) and quadrature (Q) imbalance correction or de-skew. This alters the delays through the modem processing paths. The delay uncertainty can be microseconds different from power-up cycle to power-up cycle.

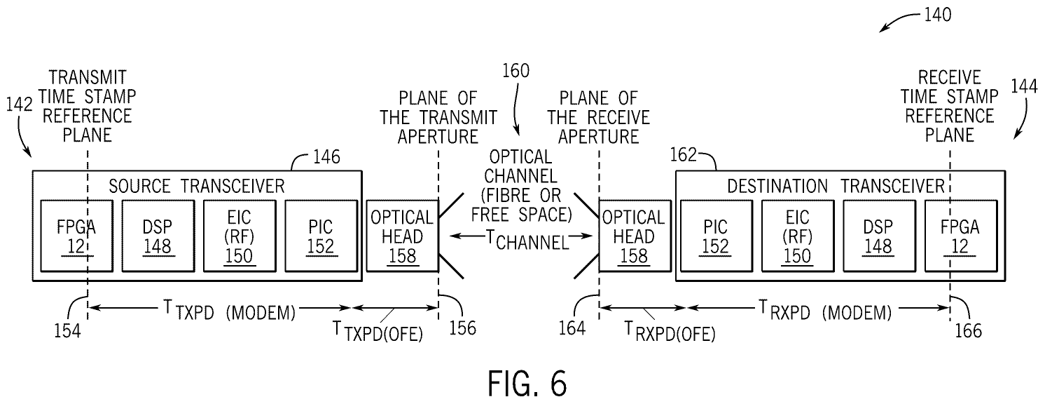

FIG. 6 illustrates the various delays through different segments of a communication system 140 (e.g., two satellites of a satellite constellation or a trading platform and an exchange). A source device 142 (e.g., a first satellite) may communicate with a destination device 144 (e.g., a second satellite). The source device 142 includes a source transceiver 146 (e.g., an OISL modem 78 of FIG. 4), which may be used for transmitting or receiving; for illustrative purposes, here, it is shown to be used for transmitting. The source transceiver 146 includes several components (e.g., multiple integrated circuit dies in a multi-die package). These may include an integrated circuit device 12 (e.g., an FPGA), a digital signal processor (DSP) 148, an electrical integrated circuit (EIC) 150, and a photonics integrated circuit (PIC) 152. The source transceiver 146 is coupled to an optical head 158 (e.g., an optical head 80 of FIG. 4).

The integrated circuit device 12 of the source transceiver 146 may process and apply a transmit timestamp to a message that is being transmitted. The transmit timestamp is applied at a point in the processing referred to as a transmit time stamp reference plane 154. The transmit timestamp is meant to represent the time at which the message exits the optical head 158 of the source transceiver 146 and begins to traverse an optical channel 160 (e.g., free space, an optical fiber), which is referred to in FIG. 6 as a plane of the transmit aperture 156. Thus, the transmit timestamp may be determined by the integrated circuit device 12 as a time indicated by a reference clock, offset by the total delay between the transmit time stamp reference plane 154 and the plane of the transmit aperture 156. As shown in FIG. 6, the delay between the transmit time stamp reference plane 154 and the plane of the transmit aperture 156 includes a delay due to the optical head 158 (T_{TXPD(OFE)}) and a delay due to a transmit signal path 161 of the source transceiver 146 (T_{TXPD(modem)}). The delay due to the optical head 158 (T_{TXPD(OFE)}) may be determined using existing techniques, while the delay due to the transmit signal path 161 of the source transceiver 146 (T_{TXPD(modem)}) may be determined according to the systems and methods of this disclosure.

The message may traverse the optical channel 160 (T_{channel}) to reach an optical head 158 of a destination transceiver 162 of the destination device 144. The destination transceiver 162 likewise includes several components (e.g., multiple integrated circuit dies in a multi-die package), which may include an integrated circuit device 12 (e.g., an FPGA), a digital signal processor (DSP) 148, an electrical integrated circuit (EIC) 150, and a photonics integrated circuit (PIC) 152. The integrated circuit device 12 of the destination transceiver 162 may apply a receive timestamp to the message indicating the moment that the message was received at the optical head 158 of the destination transceiver 162, shown as a plane of the receive aperture 164 in FIG. 6. The receive timestamp is applied at a point in the processing referred to as a receive time stamp reference plane 166.

The receive timestamp should represent the time at which the message enters the optical head 158 of the destination transceiver 162. Thus, the receive timestamp may be determined by the integrated circuit device 12 as a time indicated by a reference clock, offset by the total delay between the plane of the receive aperture 164 and the receive time stamp reference plane 166. As shown in FIG. 6, the delay between the plane of the receive aperture 164 and the receive time stamp reference plane 166 includes a delay due to the optical head 158 (T_{RXPD(OFE)}) and a delay due to a receive signal path 167 of the destination transceiver 162 (T_{RXPD(modem)}). The delay due to the optical head 158 (T_{RXPD(OFE)}) may be determined using existing techniques, while the delay due to the receive signal path 167 of the destination transceiver 162 (T_{RXPD(modem)}) may be determined according to the systems and methods of this disclosure.

The time it takes the message to traverse the optical channel 160 (T_{channel}) is a function of the distance between the optical head 158 of the source transceiver 146 and an optical head 158 of the destination transceiver 162. Thus, by identifying the difference between the transmit time stamp and the receive time stamp of a particular message where the transmit time stamp and the receive time stamp have been offset due to the modem and optical head delays—the distance between the optical head 158 of the source transceiver 146 and an optical head 158 of a destination transceiver 162 may be precisely calculated. Given the transmit timestamp (Tₜᵣₐₙₛₘᵢₜ) and the receive timestamp (T_{receive}), the range equation can be stated mathematically as follows:

$$\begin{matrix}Range between two satellites = {cT}_{channel} \\ where c is defined as the speed of light ( \sim 3 \times {10}^{8} m / s ) and \\ {T}_{channel} = {T}_{receive} - {T}_{transmit} - {T}_{transmit path delay} - {T}_{receive path delay ,}\end{matrix}$$

$$where$$

$${T}_{transmit path delay} = {T}_{TXPD ( modem )} + {T}_{TXPD ( OFE )}$$

$$and$$

$${T}_{receive path delay} = {T}_{RXPD ( OFE )} + {T}_{RXPD ( modem )}$$

FIG. 7 is a flowchart 170 of a method for determining the transmit path delay and the receive path delay of a transceiver (e.g., the transceiver 146, the transceiver 162, the OISL modem 78). The method may be performed using an integrated circuit device 12 (e.g., an FPGA programmed with a system design according to this disclosure) or any other suitable processing circuitry. The delay of the transmit signal path (e.g., T_{TXPD(modem)}) of the transceiver may be determined based on a calibration signal that is sent through the transceiver (process block 172). A total delay of the transmit signal path (e.g., T_{RXPD(modem)}) and the receive signal path (e.g., T_{RXPD(modem)}) may be determined based on feeding the calibration signal from the transmit signal path into the receive signal path of the transceiver (process block 174). The receive signal path (e.g., T_{RXPD(modem)}) may be determined by subtracting the delay of the transmit signal path (e.g., T_{TXPD(modem)}) of the transceiver from the total delay of the transmit signal path (e.g., T_{TXPD(modem)}) and the receive signal path (e.g., T_{RXPD(modem)}) of the transceiver (process block 176).

FIG. 8 is a flowchart corresponding to process block 172 of the flowchart 170 of FIG. 7, representing a method for determining the delay of the transmit signal path (e.g., T_{TXPD(modem)}) of the transceiver. The integrated circuit device 12 or another component may generate and send a calibration sequence signal over two different paths: a transmit calibration path with a known delay and the transmit signal path having an unknown delay (process block 180). The calibration sequence signal may have a relatively low frequency. For example, whereas the integrated circuit device 12 may operate at several hundred MHz to several GHz, the calibration sequence signal may be orders of magnitude lower (e.g., 1 MHz, 100 kHz, 10 kHz) and may be accomplished by generating a repeating square wave formed by many (e.g., 50, 100, 1000) consecutive pulses of logical 0 s followed by many (e.g., 50, 100, 1000) consecutive pulses of logical is. The calibration sequence signal may be measured at the end of the transmit calibration path and the transmit signal path. The difference between the calibration sequence signal traversing the two paths may be used to determine the delay of just the transmit signal path (e.g., by accounting for the known delay of the transmit calibration path).

The total delay of the transmit signal path may be equal to a total integer baud rate delay of the calibration sequence signal along the transmit signal path plus a fractional baud rate delay corresponding to a phase difference between the calibration sequence signal traversing the transmit signal path and the transmit calibration path. This allows for a highly precise determination that may be far more precise than the relatively low-frequency calibration sequence signal or even the clock frequency of the integrated circuit device 12. Thus, determining the delay of the transmit signal path may involve determining an integer delay based on a count of the integer number of pulses between the start and initial receipt of the calibration sequence signal (process block 182). The fractional delay may be determined based on a phase difference between the calibration sequence signal traversing the transmit calibration path and the transmit signal path (process block 184). These values may be summed to determine the total delay of the transmit signal path (process block 186).

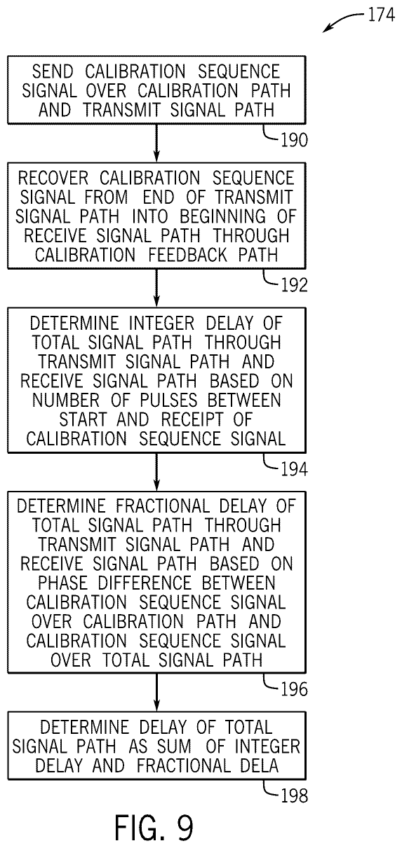

FIG. 9 is a flowchart corresponding to the process block 174 of the flowchart 170 of FIG. 7, representing a method for determining the delay of the transmit signal path (e.g., T_{TXPD(modem)}) plus the receive signal path (e.g., T_{RXPD(modem)}) of the transceiver. The integrated circuit device 12 or another component may generate and send a calibration sequence signal over two different paths: a receive calibration path with a known delay and the transmit signal path having an unknown delay (process block 190). At the end of the transmit signal path, the calibration sequence signal may be fed back into an input of the receive signal path of the transceiver through a calibration feedback path (block 192). The calibration sequence signal may be measured at the end of the receive calibration path and the receive signal path. The difference between the calibration sequence signal traversing the two paths may be used to determine the delay of the transmit signal path plus the receive signal path (e.g., by accounting for the known delay of the receive calibration path).

The total delay of the transmit signal path and the receive signal path may be equal to a total integer delay of calibration sequence signal pulses along the transmit signal path and receive signal path plus a fractional delay corresponding to a phase difference between the calibration sequence signal traversing the transmit signal path and the receive signal path and the receive calibration path. This, too, allows for a highly precise determination that may be far more precise than the relatively low-frequency calibration sequence signal or even the clock frequency of the integrated circuit device 12. Thus, determining the delay of the transmit signal path plus the receive signal path may involve determining an integer delay based on a count of the integer number of pulses between the start of the calibration sequence signal and the initial receipt of the calibration sequence signal at the output of the receive signal path (process block 194). The fractional delay may be determined based on a phase difference between the calibration sequence signal traversing the receive calibration path and the receive signal path through the transmit signal path (process block 196). These values may be summed to determine the total delay of the transmit signal path (process block 198).

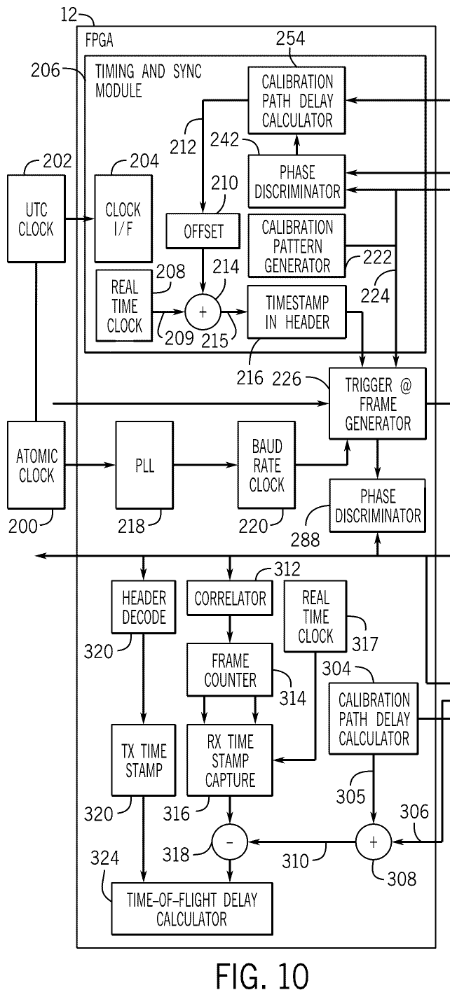

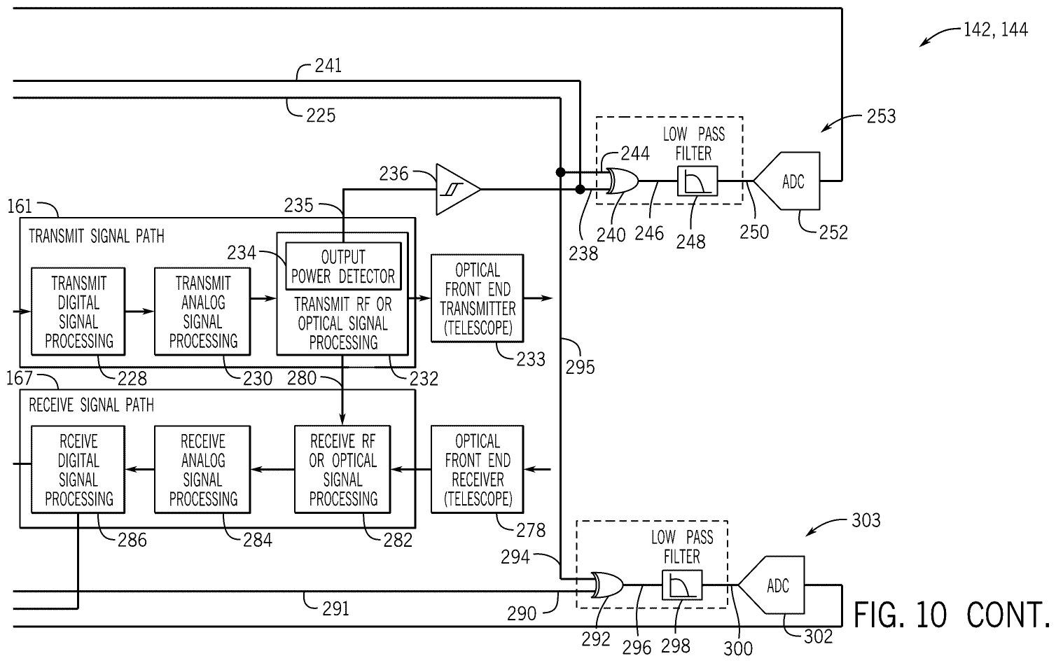

FIG. 10 illustrates various components of a transceiver 142, 144 that enable the delay calculations of the flowcharts of FIGS. 7-9. A highly precise clock, such as an atomic clock 200, may supply a reference time to the transceiver 142, 144. For example, the atomic clock 200 may supply a reference time for a coordinated universal time (UTC) clock 202. Correspondingly, the UTC clock 202 may supply a reference time to a clock interface (i/f) 204, such as an inter-range instrumentation group (IRIG) interface, of a timing and synchronization module 206 (e.g., delay calibration circuitry) running on the integrated circuit device 12. The timing and synchronization module 206 may represent part of a system design programmed into programmable logic (e.g., programmable logic 30 shown in FIG. 2) or software executed on a data processing system (e.g., instructions stored on a tangible, non-transitory medium such as a memory device, executed by one or more processors of a data processing system). A real-time clock 208 having any suitable precision for time synchronization may supply a present time value 209 that is combined with an offset time 210 corresponding to a transmit path delay value 212 (representing the transmit signal path 161 delay plus the optical front end delay) in an addition operation 214. The result is a delay-calibrated time 215 that can be used to generate a precise timestamp 216 for a header of an outgoing message. The atomic clock 200 also provides a reference clock signal to regulate a phase-locked loop (PLL) 218 that supplies a clock signal to a baud rate clock 220.

A calibration pattern source 222 generates or passes along a calibration sequence signal 224 that may be used to identify the delay across the transmit signal path 161 and the receive signal path 167. The calibration sequence signal 224 may take any suitable form. For example, the calibration sequence signal 224 may have an on-off-keying (OOK) modulation scheme that can be traverse the circuitry of the transceiver and be detected at its output. The modulation scheme employed by the transceiver (and thus applied as the calibration sequence signal 224) could be another modulation scheme such as, for example, pulse position modulation (PPM) or pulse amplitude modulation (PAM). The translation of the output signal could also be supported, such as differential phase shift keying (DPSK) or binary phase shift keying (BPSK), among others. Direct electrical digital signals from a transmitter block can also be envisaged, such as those from an ethernet interface, for example.

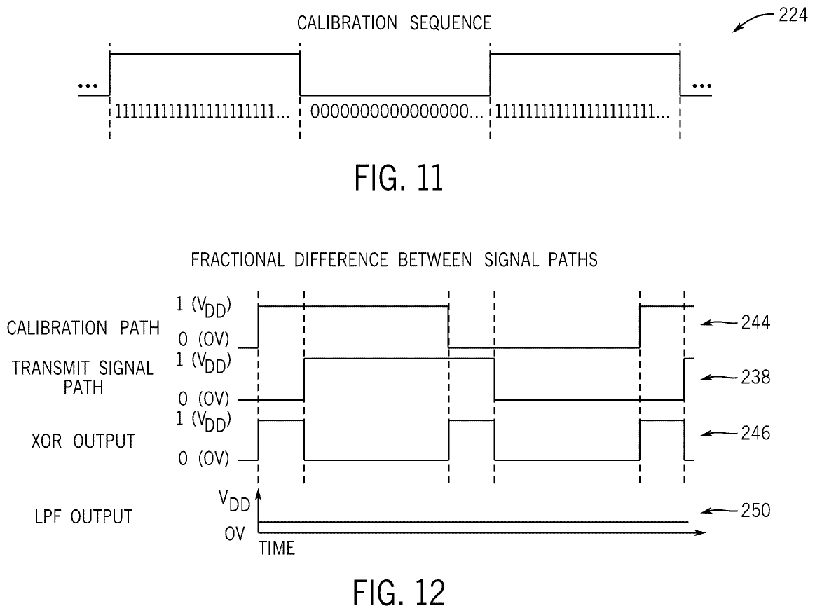

Turning briefly to FIG. 11, a timing diagram illustrating one example of the calibration sequence signal 224 is illustrated. The calibration sequence signal 224 may be any suitable signal that may be used to identify a fractional value. Indeed, the calibration sequence signal 224 may have a relatively low frequency. For example, whereas the integrated circuit device 12 may operate at several hundred MHz to several GHz, the calibration sequence signal may be significantly lower (e.g., 250 MHz, 125 MHz, 100 MHz, 50 MHz, 10 MHz, 5 MHz, 1 MHz, 500 kHz, 100 kHz, 10 kHz) and may be accomplished by generating a repeating square wave formed by many (e.g., 50, 100, 1000) consecutive pulses of logical 0 s followed by many (e.g., 50, 100, 1000) consecutive pulses of logical is. In some embodiments, the calibration sequence signal 224 is symmetric and the logical high pulses are equal in number to the logical low pulses. In other embodiments, the calibration sequence signal 224 is asymmetric and the logical high pulses are not equal in number to the logical low pulses.

Returning to FIG. 10, the calibration sequence signal 224 may be provided to a transmit calibration path 225 and to a frame generator 226, which may trigger when a new message is to begin. Indeed, the frame generator 226 may trigger when the calibration is initially received. The difference in time between when the initial receipt of the calibration sequence signal 224 causes the frame generator 226 to trigger and when the calibration sequence signal 224 is detected after passing through the transmit signal path 161 may provide a coarse measurement of the delay. For example, an integer number of pulses may be counted between when the initial receipt of the calibration sequence signal 224 causes the frame generator 226 to trigger and when the calibration sequence signal 224 is detected after passing through the transmit signal path 161.

After entering the frame generator 226, the calibration sequence signal 224 traverses transmit digital signal processing circuitry 228 (e.g., part of the DSP 148 shown in FIG. 6), transmit analog signal processing circuitry 230 (e.g., part of the EIC 150 shown in FIG. 6), and transmit RF or optical signal processing circuitry 232 (e.g., part of the PIC 152 shown in FIG. 6). To simulate the full traversal of a signal through the transmit signal path 161 to an optical front end transmitter (telescope) 233 (e.g., an optical head 158, 80), an output power detector 234 may detect the resulting optical signal (or, in the case of RF circuitry, an RF signal) and generate, on a transmit output path 235, an electrical current signal corresponding to the calibration sequence signal 224 at the transmit RF or optical signal processing circuitry 232. For example, the output power detector 234 may include a photodiode or electrical sensor at the output of the transmit signal path 161 that measures the transition from a 0 to a 1 in the modulated signal and results in the electrical current signal on the transmit output path 235. The time of arrival of the electrical current signal on the transmit output path 235 thus represents the delay of the transmit signal path 161.

A limiting transimpedance amplifier (TIA) 236 converts the electrical current signal on the transmit output path 235 into a voltage signal 238. The dark current of the output power detector 234 (e.g., photodiode) means that the TIA 236 threshold is set above this dark current threshold. If light is on the output power detector, a current is generated, which is transformed to a voltage representative of a logic 1. Note again that the calibration sequence signal 224 may be deliberately selected to a relatively low frequency square wave (e.g., 10 MHz, 50 MHz, 75 MHz, 100 MHz, 125 MHz, 150 MHz, 250 MHz). This may enable a photodiode of the output power detector 234 to generate the electrical current signal on the transmit output path 235 and allow the TIA 236 to convert the current pulses of the electrical current signal on the transmit output path 235 into the voltage signal 238 despite the relatively low bandwidth of wire traces and/or the TIA 236 of the transceiver 142, 144.

In other words, if the calibration sequence signal 224 were a higher-frequency signal (e.g., approaching the clock frequency of the integrated circuit device 12), it might be significantly filtered out by the relatively lower bandwidth wire trances. At the same time, because the calibration sequence signal 224 is a relatively low-frequency signal, measuring just an integer number of pulses of the calibration sequence signal 224 would not provide a sufficient level of precision to compute delay. As such, a fractional delay may be determined.

To determine the fractional delay, the voltage signal 238 may enter an XOR phase detector 240 and traverses a path 241 to a phase discriminator 242. Meanwhile, the calibration sequence signal 224 also enters the phase discriminator 242 and traverses the transmit calibration path 225 to enter the XOR phase detector 240 as a delayed calibration sequence signal 244. The paths 225, 235, and 241 have certain finite delays (e.g., finite delay A, finite delay B) that may be experimentally measured or modeled in advance (e.g., during design or manufacture). These finite delays are taken into account when computing the total or relative delays. The output of the XOR phase detector 240 is a fractional signal 246 having a duty cycle corresponding to a difference in phase between the signals 238 and 244. The fractional signal 246 is filtered in a low-pass filter 248 to produce a steady-state voltage 250 that corresponds to the duty cycle of the fractional signal 246. An analog-to-digital converter (ADC) 252 may convert the steady-state voltage 250 into a digital value that is supplied to a calibration path delay calculator 254. The XOR phase detector 240, the low-pass filter 248, and the ADC 252 collectively operate as a fractional phase detector 253 that can precisely determine a digital value of a phase difference between the signals 238 and 244.

An example is shown in FIG. 12. A delayed calibration sequence signal 244 on the transmit calibration path 225 is compared to the voltage signal 238 (which represents the calibration sequence signal as delayed by the transmit signal path 161) in the XOR phase detector 240. The output of the XOR phase detector 240 is the fractional signal 246. As seen in FIG. 12, the fractional signal 246 has a logical high value only when the signals 244 and 238 are different. Thus, the fractional signal 246 would have a duty cycle of 0% if the signals 244 and 238 were completely in phase and the fractional signal 246 would have a duty cycle of 100% if the signals 244 and 238 were completely out of phase. The steady-state voltage 250 that results from the low-pass filtering the fractional signal 246 thus varies depending on the duty cycle of the fractional signal 246.

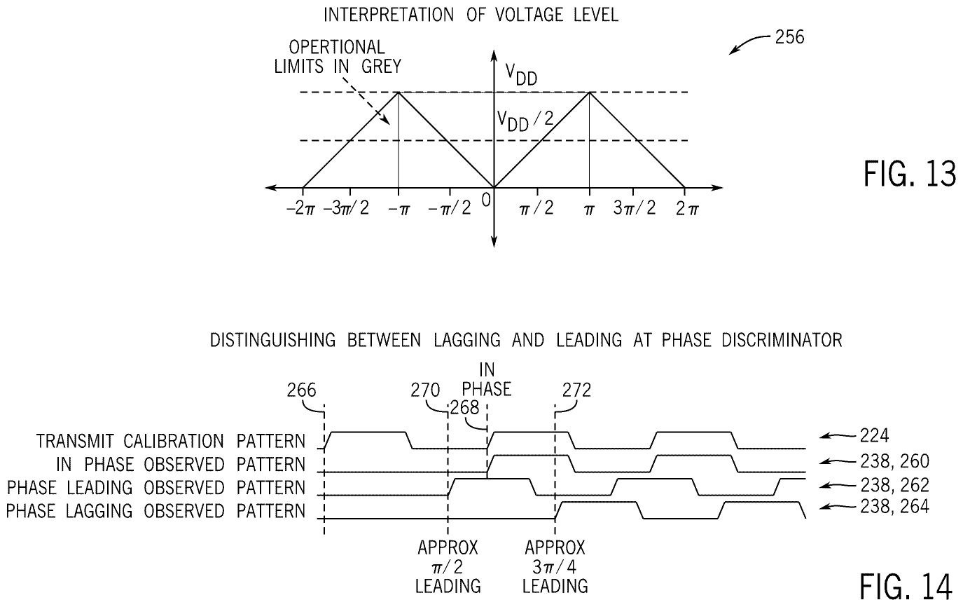

A plot 256 shown in FIG. 13 illustrates an interpretation of the voltage level of the steady-state voltage 250 that enters the ADC 252. The steady-state voltage 250 would have a value of 0V (corresponding to the fractional signal 246 having a duty cycle of 0%) when the signals 244 and 238 are completely out of phase. The steady-state voltage 250 would have a value of a high voltage (V_{DD}) (corresponding to the fractional signal 246 having a duty cycle of 100%) when the signals 244 and 238 are completely out of phase. Therefore, the voltage level between 0V and V_{DD} corresponds to the relative phase difference being between 0 and π or −π.

The ADC 252 is used to convert the low pass filter 248 output steady-state voltage 250 to a digital value representing a phase difference of the two input signals 238 and 244 to the XOR phase detector 240. For example, the ADC 252 may have N bits resolution, where N represents any suitable integer that allows the ADC 252 to quantize over a sufficiently precise dynamic range. For example, the ADC 252 may have N bits resolution that allows it to quantize over the full dynamic range of the low pass filter 248, which can be the V_{DD} supply rail of the XOR phase detector 240. The quantization step is Qᵥ=(V_{DD}/((2\hat{ }N)−1). The range between 0V and V_{DD} represents, for example, 0 to π (or −π) range. When the output sequence has a 100 MHz period, this means that a 2π period= 1/100 MHz=10 nS. Therefore, the π phase detector range equates to 5 ns. Thus, this low pass filter 248 steady-state voltage 250 range quantized by a 16-bit ADC 242 is able to resolve a quantization resolution step of approximately 7 femto-seconds. This will be limited by noise and unaccounted delay offsets from the sense feedback points. This is much better than current state-of-the-art capabilities of using high speed digital clocks to measure time.

It may not be possible to tell, from the steady-state voltage signal 250 alone, whether the voltage signal 238 from the transmit signal path 161 is lagging or leading the delayed calibration sequence signal 244 from the transmit calibration path 225. As such, the phase discriminator 242 may ascertain, through a coarse comparison of the calibration sequence signal 224 and the voltage signal 238 (accounting for the finite delay of the path 241), whether the voltage signal 238 is leading or lagging.

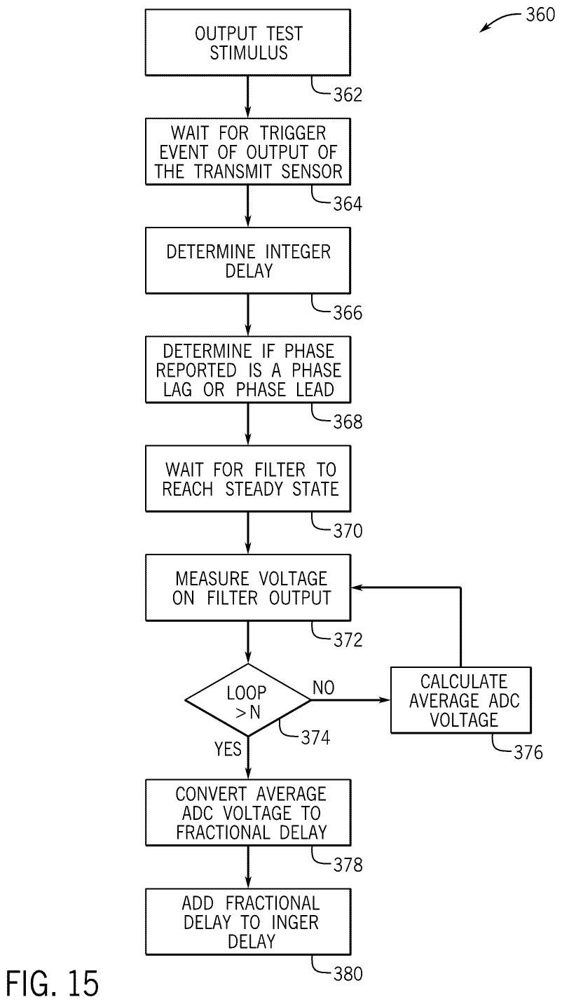

The phase discriminator 242 may operate according to an example shown in FIG. 14. The phase discriminator may determine that the incoming voltage signal 238 from the path 241 is lagging or leading the calibration sequence signal 224 based on when the pulses of the voltage signal 238 are in-phase 260, phase leading 262, or phase lagging 264. A start 266 of the calibration sequence signal 224 occurs before the voltage signal 238 reaches the phase discriminator 242. The voltage signal 238 is in phase (signal 260) when a voltage rise time 268 (or fall time) of the voltage signal 238 matches a corresponding voltage rise time 268 (or fall time) of the calibration sequence signal 224. The voltage signal 238 is leading (signal 262) when a voltage rise time 270 of the voltage signal 238 occurs while the calibration sequence signal 224 is low. The voltage signal 238 is lagging (signal 264) when a voltage rise time 272 of the voltage signal 238 happens while the calibration sequence signal 224 is high.

Returning to FIG. 10, the calibration path delay calculator 254 uses the digital value of fractional phase from the ADC 252 and a leading/lagging indication from the phase discriminator 242 to determine the transmit path delay value 212 corresponding to the integer delay plus the fractional delay, accounting for the finite delays of the paths 225 and 241. The calibration path delay calculator 254 also includes delay introduced by the optical front end transmitter (telescope) 233, which may be determined using any suitable systems or methods.

Determining the delay of the receive signal path 167 may be done by determining the delay of the transmit signal path 161 and the receive signal path 167 together and then subtracting the transmit path delay value 212. Indeed, the calibration sequence signal 224 may be provided via the frame generator 226 through the transmit signal path 161 (e.g., the transmit digital signal processing circuitry 228, the transmit analog signal processing circuitry 230, and the transmit RF or optical signal processing circuitry 232). To simulate the behavior of the receive signal path 167 when an optical signal is received from an optical front end receiver (telescope) 278 (e.g., of an optical head 80, 158), an RF or optical signal generated by the transmit RF or optical signal processing circuitry 232 may be provided via a calibration feedback path 280 into receive RF or optical signal processing circuitry 282 (e.g., part of the PIC 152 shown in FIG. 6). The signal may propagate through receive analog signal processing circuitry 284 (e.g., part of the EIC 150 shown in FIG. 6) and receive digital signal processing circuitry 286 (e.g., part of the DSP 148 shown in FIG. 6). The resulting signal may be provided to a phase discriminator 288, which may receive the calibration sequence signal 224 from the calibration pattern source 222. The phase discriminator 288 may operate in a comparable way to the phase discriminator 242.

The output of the receive digital signal processing circuitry 286 may be a digital voltage signal 290 that is sent over a path 291 to an XOR phase detector 292. The XOR phase detector 292 may compare the digital voltage signal 290 to a delayed calibration sequence signal 294 corresponding to the calibration sequence signal 224 from the calibration pattern source 222 across a receive calibration path 295 having a finite delay. Here, the receive calibration path 295 includes the transmit calibration path 225 plus an additional, further path to reach the XOR phase detector 292, but in other cases, the receive calibration path 295 may be completely distinct from the transmit calibration path 225. The XOR phase detector 292 may output a fractional signal 296 having a duty cycle corresponding to a difference in phase between the signals 290 and 294. The fractional signal 296 is filtered in a low-pass filter 298 to produce a steady-state voltage 300 that corresponds to the duty cycle of the fractional signal 296. An analog-to-digital converter (ADC) 302 may convert the steady-state voltage 300 into a digital value that is supplied to a receive calibration path delay calculator 304. These components operate in a comparable manner to the XOR phase detector 240, the low-pass filter 248, the ADC 252, and the calibration path delay calculator 254. The XOR phase detector 292, the low-pass filter 298, and the ADC 302 collectively operate as a fractional phase detector 303 that can precisely determine a digital value of a phase difference between the signals 290 and 294.

The calibration path delay calculator 304 may use the digital value of fractional phase from the ADC 302 and a leading/lagging indication from the phase discriminator 288 to determine a receive path delay value 305. The calibration path delay calculator 304 also accounts for delay introduced by the optical front-end receiver (telescope) 278, which may be determined using any suitable systems or methods. By subtracting the transmit path delay from a total transmit and receive path delay value, corresponding to the integer delay of the transmit and receive paths plus the fractional delay of the transmit and receive paths, and also accounting for the finite delays of the various other paths (e.g., 225, 241, 291, 295), the calibration path delay calculator 304 obtains the receive path delay value 305.

The receive digital signal processing circuitry 286 may sometimes experience a slight intra-symbol error during clock and data recovery (CDR). As such, a delay corresponding to a CDR timing error detection (TED) error value 306 may be combined with the receive path delay value 305 in an addition operation 308. The CDR TED error value 306 or a filtered version of that signal can be used to correct for quantization errors in the integer and fractional delay calculation in the receive path delay value 305. This produces an adjusted receive path delay value 310, which may be used as an offset to a receive timestamp to accurately account for the delay through the receive signal path 167 that an incoming message will have experienced.

The calculated delays may be used to determine a time-of-flight of messages from another transceiver 142, 144 (e.g., from another satellite). To obtain a receive timestamp from incoming receive data, a correlator 312 may identify frames of an incoming message and, using a frame counter 314, may capture a defined frame at which a receive timestamp is to be applied using receive timestamp capture circuitry 316. The receive timestamp capture circuitry 316 may operate based on a frame count from the frame counter 314 and a valid signal to indicate when valid receive data is incoming. The receive timestamp capture circuitry 316 may produce the timestamp based on a real-time clock 317 in a receive clock domain that may be separate from a clock domain of the transmit path. The receive timestamp from the receive timestamp capture circuitry 316 is offset by the adjusted receive path delay value 310 in a subtraction operation 318. Meanwhile, header decode circuitry 320 may decode a header of the incoming receive data to extract a transmit timestamp (e.g., sent by a transceiver 142, 144 from the other satellite). The difference in time between the receive timestamp and the transmit timestamp may be used by a time-of-flight delay calculator 324 to precisely calculate the distance between the two transceivers 142, 144 that are exchanging messages (e.g., based on the equations above).

A flowchart 360 of FIG. 15 summarizes a manner of using the circuitry of FIG. 10 to determine a delay through the transmit signal path of a transceiver or through the transmit signal path and the receive signal path of the transceiver. At process block 362, a calibration sequence signal is output as a test stimulus. Based on a trigger event corresponding to an output of the transmit sensor (process block 364), an integer delay value may be determined (process block 366). A phase discriminator determines whether the difference between the output of the transmit sensor is leading or lagging the calibration sequence signal (process block 368). This may happen even before the low-pass filter (e.g., 248, 298) reaches steady state. After waiting for the low-pass filter (e.g., 248, 298) to reach steady state (process block 370), the ADC (e.g., 252, 302) may obtain digital samples of the analog voltage. If desired, N samples may be obtained, where N is an integer value that sufficiently reduces analog noise errors (e.g., 2 samples, 5 samples, 10 samples, 20 samples, 50 samples, 100 samples, 200 samples, 500 samples, 1000 samples, 2000 samples, 5000 samples, 10,000 samples, or the like). While the number of samples is less than N (decision block 374), another sample may be obtained and used averaged in the ADC voltage value (process block 376). Once more than N samples are obtained (decision block 374), an average of the ADC voltage may be converted to fractional delay (process block 378) and the resulting fractional delay may be added to the integer delay to obtain total delay (process block 380).

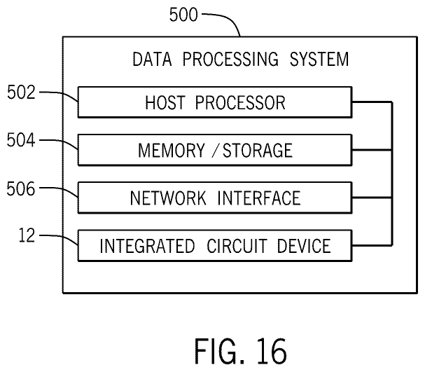

The integrated circuit device 12 discussed above may be a component included in a data processing system, such as a data processing system 500, shown in FIG. 16. The data processing system 500 may include the integrated circuit device 12 (e.g., a programmable logic device, an application specific integrated circuit (ASIC)), a host processor 502, memory and/or storage circuitry 504, and a network interface 506 (e.g., a transceiver). The data processing system 500 may include more or fewer components (e.g., electronic display, user interface structures, application specific integrated circuits (ASICs)). Moreover, any of the circuit components depicted in FIG. 7 may include the NOC 46 of the integrated circuit device 12. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams) for programming the integrated circuit device 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. A System Comprising One or More Integrated Circuits, the System comprising:
delay calibration circuitry configured to allow determination of a delay through a transmit signal path between a calibration sequence signal source and an output of the transmit signal path;
the transmit signal path, comprising a plurality of processing stages having a possible delay variation under different conditions; and
a phase detector to determine a fractional baud rate difference between the calibration sequence signal source and a signal representative of the output of the transmit signal path.
   EXAMPLE EMBODIMENT 2. The system of example embodiment 1, wherein the calibration sequence signal has a system operational baud rate or an integer divisor thereof.
   EXAMPLE EMBODIMENT 3. The system of example embodiment 1, wherein the calibration sequence signal comprises a series of consecutive values corresponding to a first logical state followed by a series of consecutive values corresponding to a second logical state.
   EXAMPLE EMBODIMENT 4. The system of example embodiment 1, wherein the delay calibration circuitry comprises:
the calibration sequence signal source configured to input the calibration sequence signal to send through the transmit signal path;
a phase discriminator configured to indicate whether the output of the transmit signal path leads or lags phase compared to the calibration sequence signal from the calibration sequence signal source; and
a calibration path delay calculator configured to determine the transmit signal path delay based on at least an integer baud rate delay of a start of the calibration sequence signal to a first output of the transmit signal path and the fractional baud rate difference.
   EXAMPLE EMBODIMENT 5. The system of example embodiment 1, wherein the plurality of processing stages of the transmit signal path comprise:
digital signal processing circuitry;
analog signal processing circuitry; and
radio frequency or optical processing circuitry.
   EXAMPLE EMBODIMENT 6. The system of example embodiment 1, wherein the phase detector comprises:
an XOR phase detector configured to compare a signal representative of the output of the transmit signal path and that of the calibration sequence signal;
a low-pass filter configured to average an output of the XOR phase detector to output an analog voltage signal; and
an analog-to-digital converter configured to generate a digital value corresponding to the analog voltage signal output by the low-pass filter.
   EXAMPLE EMBODIMENT 7. The system of example embodiment 1, comprising:
a clock configured to provide a time basis for a transmit timestamp; and
addition circuitry to add an offset to the time basis to account for the transmit signal path delay in the transmit timestamp.
   EXAMPLE EMBODIMENT 8. A method comprising:
sending a calibration sequence signal having a system operational baud rate of a transceiver or an integer divisor thereof from a calibration sequence signal source through a transmit signal path of the transceiver;
determining an integer baud rate delay of a start of the calibration sequence signal to a first output of the transmit signal path corresponding to an integer number of pulses of the calibration sequence signal between the start of the calibration sequence signal and the first output of the transmit signal path;
determining a fractional baud rate difference between the calibration sequence signal source and a signal representative of the output of the transmit signal path; and
determining a total delay of the transmit signal path based on a sum of the integer baud rate delay and the fractional baud rate difference.
   EXAMPLE EMBODIMENT 9. The method of example embodiment 8, comprising generating the calibration sequence signal based on a series of consecutive values corresponding to a first logical state followed by a series of consecutive values corresponding to a second logical state.
   EXAMPLE EMBODIMENT 10. The method of example embodiment 9, wherein the calibration sequence signal comprises a pulse amplitude modulation (PAM) signal and the first logical state comprises a first PAM level and the second logical state comprises a second PAM level.
   EXAMPLE EMBODIMENT 11. The method of example embodiment 8, wherein the total delay comprises a delay due to an optical head in addition to the sum of the integer baud rate delay and the fractional baud rate difference.
   EXAMPLE EMBODIMENT 12. The method of example embodiment 8, comprising:
sending the calibration sequence signal through the transmit signal path and a receive signal path of the transceiver;
determining an integer baud rate delay of the start of the calibration sequence signal to a first output of the receive signal path corresponding to an integer number of pulses of the calibration sequence signal between the start of the calibration sequence signal and the first output of the receive signal path;
determining a fractional baud rate difference between the calibration sequence signal source and the output of the receive signal path; and
determining a total delay of the receive signal path based on a sum of the integer baud rate delay of the start of the calibration sequence signal to the first output of the receive signal path and the fractional baud rate difference between the calibration sequence signal source and the output of the receive signal path, less the total delay of the transmit signal path.
   EXAMPLE EMBODIMENT 13. The method of example embodiment 12, wherein sending the calibration sequence signal through the transmit signal path and the receive signal path comprises sending the calibration sequence signal through a calibration feedback path between the transmit signal path and the receive signal path.
   EXAMPLE EMBODIMENT 14. The method of example embodiment 12, wherein the total delay of the receive signal path is determined based at least on a clock and data recovery (CDR) timing error detection (TED) error.
   EXAMPLE EMBODIMENT 15. The method of example embodiment 8, wherein determining the fractional baud rate difference between the calibration sequence signal source and the signal representative of the output of the transmit signal path comprises:
using an XOR phase detector to compare the signal representative of the output of the transmit signal path and that of the calibration sequence signal;
using a low-pass filter to average an output of the XOR phase detector to output an analog voltage signal; and
using an analog-to-digital converter to generate a digital value corresponding to the analog voltage signal output by the low-pass filter.
   EXAMPLE EMBODIMENT 16. One or more tangible, non-transitory, machine-readable media comprising a system design that, when programmed into an integrated circuit device, comprises:
a calibration sequence signal source configured to provide a calibration sequence signal to send through a transmit signal path between the calibration sequence signal source and an output of the transmit signal path;
a phase discriminator configured to indicate whether the output of the transmit signal path leads or lags phase compared to the calibration sequence signal from the calibration sequence signal source; and
a calibration path delay calculator configured to determine a transmit signal path delay based on at least an integer baud rate delay of a start of the calibration sequence signal to a first output of the transmit signal path and a fractional baud rate difference based at least on whether the output of the transmit signal path leads or lags phase compared to the calibration sequence signal from the calibration sequence signal source.
   EXAMPLE EMBODIMENT 17. The one or more tangible, non-transitory, machine-readable media of example embodiment 16, wherein the calibration path delay calculator is configured to account for a finite delay of the calibration sequence signal through a calibration path.
   EXAMPLE EMBODIMENT 18. The one or more tangible, non-transitory, machine-readable media of example embodiment 16, wherein the integrated circuit device comprises a programmable logic device.
   EXAMPLE EMBODIMENT 19. The one or more tangible, non-transitory, machine-readable media of example embodiment 16, wherein the integrated circuit device is part of a system comprising:
an XOR phase detector configured to compare a signal representative of the output of the transmit signal path and that of the calibration sequence signal;
a low-pass filter configured to average an output of the XOR phase detector to output an analog voltage signal; and
an analog-to-digital converter configured to generate a digital value corresponding to the analog voltage signal output by the low-pass filter, wherein the calibration path delay calculator is configured to determine the fractional baud rate difference based at least on the digital value corresponding to the analog voltage signal output by the low-pass filter.
   EXAMPLE EMBODIMENT 20. The one or more tangible, non-transitory, machine-readable media of example embodiment 16, wherein the calibration sequence signal source is configured to generate the calibration sequence signal to send through the transmit signal path and a receive signal path, and wherein the system design, when programmed into the integrated circuit device, comprises:
a second phase discriminator configured to indicate whether an output of the receive signal path leads or lags phase compared to the calibration sequence signal from the calibration sequence signal source; and
a second calibration path delay calculator configured to determine a receive path delay based on at least an integer baud rate delay of the start of the calibration sequence signal to a first output of the receive signal path and a second fractional baud rate difference based at least on whether the output of the receive signal path leads or lags phase compared to the calibration sequence signal from the calibration sequence signal source.

What is claimed is:

1. A system comprising one or more integrated circuits, the system comprising:
delay calibration circuitry configured to allow determination of a delay through a transmit signal path between a calibration sequence signal source and an output of the transmit signal path;
the transmit signal path, comprising a plurality of processing stages having a possible delay variation under different conditions; and
a phase detector to determine a fractional baud rate difference between the calibration sequence signal source and a signal representative of the output of the transmit signal path.

2. The system of claim 1, wherein the calibration sequence signal has a system operational baud rate or an integer divisor thereof.

3. The system of claim 1, wherein the calibration sequence signal comprises a series of consecutive values corresponding to a first logical state followed by a series of consecutive values corresponding to a second logical state.

4. The system of claim 1, wherein the delay calibration circuitry comprises:
the calibration sequence signal source configured to input the calibration sequence signal to send through the transmit signal path;
a phase discriminator configured to indicate whether the output of the transmit signal path leads or lags phase compared to the calibration sequence signal from the calibration sequence signal source; and
a calibration path delay calculator configured to determine the transmit signal path delay based on at least an integer baud rate delay of a start of the calibration sequence signal to a first output of the transmit signal path and the fractional baud rate difference.

5. The system of claim 1, wherein the plurality of processing stages of the transmit signal path comprise:
digital signal processing circuitry;
analog signal processing circuitry; and
radio frequency or optical processing circuitry.

6. The system of claim 1, wherein the phase detector comprises:
an XOR phase detector configured to compare a signal representative of the output of the transmit signal path and that of the calibration sequence signal;
a low-pass filter configured to average an output of the XOR phase detector to output an analog voltage signal; and
an analog-to-digital converter configured to generate a digital value corresponding to the analog voltage signal output by the low-pass filter.

7. The system of claim 1, comprising:
a clock configured to provide a time basis for a transmit timestamp; and
addition circuitry to add an offset to the time basis to account for the transmit signal path delay in the transmit timestamp.

8. A method comprising:
sending a calibration sequence signal having a system operational baud rate of a transceiver or an integer divisor thereof from a calibration sequence signal source through a transmit signal path of the transceiver;
determining an integer baud rate delay of a start of the calibration sequence signal to a first output of the transmit signal path corresponding to an integer number of pulses of the calibration sequence signal between the start of the calibration sequence signal and the first output of the transmit signal path;
determining a fractional baud rate difference between the calibration sequence signal source and a signal representative of the output of the transmit signal path; and
determining a total delay of the transmit signal path based on a sum of the integer baud rate delay and the fractional baud rate difference.

9. The method of claim 8, comprising generating the calibration sequence signal based on a series of consecutive values corresponding to a first logical state followed by a series of consecutive values corresponding to a second logical state.

10. The method of claim 9, wherein the calibration sequence signal comprises a pulse amplitude modulation (PAM) signal and the first logical state comprises a first PAM level and the second logical state comprises a second PAM level.

11. The method of claim 8, wherein the total delay comprises a delay due to an optical head in addition to the sum of the integer baud rate delay and the fractional baud rate difference.

12. The method of claim 8, comprising:
sending the calibration sequence signal through the transmit signal path and a receive signal path of the transceiver;
determining an integer baud rate delay of the start of the calibration sequence signal to a first output of the receive signal path corresponding to an integer number of pulses of the calibration sequence signal between the start of the calibration sequence signal and the first output of the receive signal path;
determining a fractional baud rate difference between the calibration sequence signal source and the output of the receive signal path; and
determining a total delay of the receive signal path based on a sum of the integer baud rate delay of the start of the calibration sequence signal to the first output of the receive signal path and the fractional baud rate difference between the calibration sequence signal source and the output of the receive signal path, less the total delay of the transmit signal path.

13. The method of claim 12, wherein sending the calibration sequence signal through the transmit signal path and the receive signal path comprises sending the calibration sequence signal through a calibration feedback path between the transmit signal path and the receive signal path.

14. The method of claim 12, wherein the total delay of the receive signal path is determined based at least on a clock and data recovery (CDR) timing error detection (TED) error.

15. The method of claim 8, wherein determining the fractional baud rate difference between the calibration sequence signal source and the signal representative of the output of the transmit signal path comprises:
using an XOR phase detector to compare the signal representative of the output of the transmit signal path and that of the calibration sequence signal;
using a low-pass filter to average an output of the XOR phase detector to output an analog voltage signal; and
using an analog-to-digital converter to generate a digital value corresponding to the analog voltage signal output by the low-pass filter.

16. One or more tangible, non-transitory, machine-readable media comprising a system design that, when programmed into an integrated circuit device, comprises:
a calibration sequence signal source configured to provide a calibration sequence signal to send through a transmit signal path between the calibration sequence signal source and an output of the transmit signal path;
a phase discriminator configured to indicate whether the output of the transmit signal path leads or lags phase compared to the calibration sequence signal from the calibration sequence signal source; and
a calibration path delay calculator configured to determine a transmit signal path delay based on at least an integer baud rate delay of a start of the calibration sequence signal to a first output of the transmit signal path and a fractional baud rate difference based at least on whether the output of the transmit signal path leads or lags phase compared to the calibration sequence signal from the calibration sequence signal source.

17. The one or more tangible, non-transitory, machine-readable media of claim 16, wherein the calibration path delay calculator is configured to account for a finite delay of the calibration sequence signal through a calibration path.

18. The one or more tangible, non-transitory, machine-readable media of claim 16, wherein the integrated circuit device comprises a programmable logic device.

19. The one or more tangible, non-transitory, machine-readable media of claim 16, wherein the integrated circuit device is part of a system comprising:
an XOR phase detector configured to compare a signal representative of the output of the transmit signal path and that of the calibration sequence signal;
a low-pass filter configured to average an output of the XOR phase detector to output an analog voltage signal; and
an analog-to-digital converter configured to generate a digital value corresponding to the analog voltage signal output by the low-pass filter, wherein the calibration path delay calculator is configured to determine the fractional baud rate difference based at least on the digital value corresponding to the analog voltage signal output by the low-pass filter.

20. The one or more tangible, non-transitory, machine-readable media of claim 16, wherein the calibration sequence signal source is configured to generate the calibration sequence signal to send through the transmit signal path and a receive signal path, and wherein the system design, when programmed into the integrated circuit device, comprises:
a second phase discriminator configured to indicate whether an output of the receive signal path leads or lags phase compared to the calibration sequence signal from the calibration sequence signal source; and
a second calibration path delay calculator configured to determine a receive path delay based on at least an integer baud rate delay of the start of the calibration sequence signal to a first output of the receive signal path and a second fractional baud rate difference based at least on whether the output of the receive signal path leads or lags phase compared to the calibration sequence signal from the calibration sequence signal source.
